(19) United States
(12) Patent Application Publication
(10) Pub. No.: US 2015/0296714 A1
(43) Pub. Date: Oct. 22, 2015

(54) METHOD AND DEVICE FOR COMPRESSING LONG-STEM PLANT MATERIAL

(71) Applicant: Ingo DREHER, Balgheim (DE)

(72) Inventor: Ingo DREHER, Balgheim (DE)

(21) Appl. No.: 14/439,563

(22) PCT Filed: Oct. 23, 2013
(86) PCT No.: PCT/DE2013/100364

§ 371 Date: Apr. 29, 2015

(30) Foreign Application Priority Data
Oct. 31, 2012 (DE) 10 2012 110 417.4

(51) Int. Cl. A01F 15/04; B30B 9/30; A01F 15/10; A01F 15/08

(52) U.S. Cl. CPC A01F 15/04; A01F 15/0825; B30B 9/30; A01F 15/10; A01F 2015/108

(57) ABSTRACT

Disclosed is a method for compressing long-stem plant material in which the long-stem plant material is introduced into a compression unit and is pressed, and the long-stem plant material pressed in the compression unit is packaged to form transportable units. In the disclosed method, an amount of the long-stem plant material that is predefined on the basis of the weight thereof is introduced into the compression unit.

The invention relates to a method for compressing long-stem plant material in which the long-stem plant material is introduced into a compression unit and pressed and in which the long-stem plant material pressed in the compression unit is packaged to form transportable units.

Further, the invention relates a device for compressing long-stem plant material with a compression unit, comprising a compression chamber for the long-stem plant material, and with a feeder unit for introducing the long-stem plant material into the compression chamber of the compression unit, whereby the compression chamber has an inlet opening associated with the feeder unit, over which the long-stem plant material can be introduced into the compression chamber of the compression unit.

Bale presses, in which the compaction of the plant material occurs via a preset mechanical resistance, are customarily used today in agricultural practice for the compression shaping of hay or straw. For example, the plant material is pressed into rectangular bales in a narrowing compaction channel, whereby the pressing force is applied via mechanically acting plungers. The known method, which has been used for many years in practice, reaches its limits, however, when bulky, coarse-stemmed plant material, for example, miscanthus stems, is to be compressed. If the long stems lie in the compaction direction in the compaction channel of the compression press, they act like a mechanical plunger with the result that the plant feedstock is pushed through the pressing channel without any significant compression. The sought compaction is then not yet achieved. The result is that the plant material is ultimately only insufficiently compressed and the transport capacities cannot be efficiently utilized afterwards. Therefore, there is a decline in the economic efficiency of the entire recycling chain in the recovery of the plant material as biomass and energy source.

The object of the present invention is to provide a method and a device for compressing long-stem, particularly bulky and coarse-stemmed plant material, which due to improved compression increases the economic efficiency of the utilization of the plant material as biomass.

To achieve the object, the invention in conjunction with the preamble of claim 1 is characterized in that a long-stem plant material amount, predefined based on its weight, is introduced into the compression unit.

The particular advantage of the invention is that a plant material amount determined based on its weight is always compressed instead of compression of the plant material, guided, particularly controlled or regulated via the mechanical resistance. It is assured thereby that substantially the same amount of plant material is compressed and packaged in each compression. The orientation of the long-stem plant material in the compression unit therefore has no effect on the degree of compression. A constantly changing and particularly insufficient compression of the long-stem plant material is therefore reliably prevented. Thus, the economic efficiency in the utilization of the plant material improves, and in particular optimization of transport costs occurs, because a consistently high tonnage is achieved.

The central idea of the invention is to make the degree of compression of the plant material more uniform and in particular to increase it. In contrast to the mechanical compression method realized via flow resistance, as is typical today, for this purpose a plant material amount predefined based on its weight is pressed and packaged to form a transportable unit.

According to a preferred embodiment of the invention, the weight of the long-stem plant material is determined continuously during the filling of the compression unit. The filling of the compression unit is stopped as soon as a target weight of the long-stem plant material is reached. Advantageously, the continuous determination of the weight enables close control of the filling process. Within the scope of the invention, the weight of the plant material can be determined, for example, continuously or almost continuously or clocked at regular or irregular time intervals.

According to a refinement of the invention, the weight of the long-stem plant material introduced into the compression unit is determined, in that the weight of at least one part of the compression unit with the long-stem plant material located therein is determined by sensors and the known weight of the at least one part of the compression unit is then subtracted from the determined value (total weight). Advantageously, the weight of the long-stem plant material located in the compression unit can be determined with a high accuracy in this way particularly with the use of commercial sensors, for example, weight sensors. The compression unit, which is also weighed totally or at least partially, in this regard has a structurally established, known unladen weight (tare weight). Said weight assigned to the compression unit can be subtracted in a simple way from the total weight determined by sensors to determine the (net) weight of the long-stem plant material located in the compression unit.

In this respect, the target weight of the long-stem plant material to be introduced into the compression unit can be determined with little effort process-inherently as it were. The target weight can be fixedly predefined or be established depending on the quality of the plant material, for example, the plant species or variety, the moisture content, or other parameters relevant to the weight determination. For example, the target weight for filling the compression unit in the case of plant material with a rather high residual moisture can be selected as higher than in the case of plant material with a lower residual moisture.

According to a refinement of the invention, for compressing the long-stem plant material in the compression unit, the long-stem plant material is pressed to a predefined compression volume or to a predefined compression length. Advantageously, a consistently similar compacted body (transportable unit) is formed, which can be matched in its geometry in an optimal manner to the transport conditions, by compression to a predefined volume or a predefined length in the case of a known cross section. For example, the length, width, and height of a block-shaped bale body can be adapted to the geometry of an agricultural trailer, a semitrailer, or a shipping container. It is possible in this way to successfully utilize in an optimal manner the available transport space and to lower transportation costs significantly. Moreover, the bale body has a constant density at a constant weight and always with the same geometry. This is particularly advantageous during the utilization of the plant material, for instance, as biomass.

The compression during the pressing together of the plant material in this respect does occur in a force- or resistance-controlled manner. Rather, the pressing process is path- or volume-guided. The forces arising hereby vary depending on the orientation of the plant material in the compression unit. High pressing forces occur particularly when a plant stem is to be compressed in its longitudinal direction and must therefore bend.

According to a refinement of the invention, the long-stem plant material is pre-compacted before being introduced into the compression unit. The filling process of the compression unit can be advantageously accelerated by the pre-compaction of the long-stem plant material. At the same time, the volume of the compression unit can be reduced, if already pre-compacted plant material is filled into the compression unit. In this respect, the size of a device used for the compression method, for example, a mobile agricultural press, is reduced.

According to a refinement of the invention, before the pressing, long-stem plant material located partially in the compression unit and partially protruding out of the compression unit is severed such that parts of the long-stem plant material located in the compression unit are pressed and parts of the long-stem plant material protruding out of the compression unit remain outside the compression unit during the pressing and are therefore not pressed. Advantageously, the controllability of the compression process improves due to the upstream severing of plant material, which is provided only partially in the compression unit and partially protrudes out of the compression unit. A substantially uncontrolled movement of the free ends of the long-stem plant material is prevented. The cut but not pressed plant material can again be introduced into the compression unit and compacted, for example, in the next process step.

According to a refinement of the invention, the pressing together of the long-stem plant material occurs sequentially. Advantageously, the process parameters and particularly the degree of compression in the sequential method step can be controlled or adjusted in an especially simple manner. It has become evident in practice that deviations of less than 5% result with respect to the size and weight of the transportable units. It was possible to achieve reproducibly an accuracy of 1 to 2% in the testing.

To achieve the object, the invention in conjunction with the preamble of claim 8 is characterized in that the compression unit has a plunger movable between a home position and a compacting position, which in the home position is arranged disengaged such that the long-stem plant material can be introduced into the compression chamber and which in the compression position is arranged plunged into the compression chamber such that the long-stem plant material is provided in the compression chamber pressed together to a geometrically predefined extent.

The particular advantage of the invention is that due to the movable plunger a defined, particularly path-controlled compression of the long-stem plant material is brought about. A force-guided pressing of the long-stem plant material in the compression chamber of the compression unit can therefore be omitted. The orientation of the plant stems in the compression unit therefore has no or at most a minor effect on the degree of compression and the final volume of the transportable units. The transportable units therefore always have an already known constant size and an already known constant weight. The transport of the plant material can therefore occur in an especially economic manner.

The plunger can be operated, for example, fluidically, particularly hydraulically or pneumatically. For example, the plunger can be driven mechanically; in particular, a jack screw or a chain drive can be provided.

According to a preferred embodiment of the invention, a weight determining unit is provided, which is operatively connected to the compression unit such that a weight of at least one part of the compression unit and a weight of the long-stem plant material introduced into the compression chamber of the compression unit can be determined by the weight determining unit. Advantageously, the amount of the long-stem plant material introduced into the compression chamber of the compression unit can be determined from the weight in a simple manner and with good accuracy. Optionally the moisture of the plant material can be taken into account in the weight determination, so that with the moisture adjustment a specific amount of long-stem plant material is always pressed and packaged to form transportable units. In particular, the determination of the weight of at least one part of the compression unit (or the entire compression unit) and of the long-stem plant material located therein is simpler than the separate metrological determination of the (net) weight of the plant material alone introduced into the compression unit.

According to a refinement of the invention, a cutting unit with a cutting means is associated with the inlet opening of the compression chamber, whereby long-stem plant material protruding through the inlet opening of the compression chamber is cut off by means of the cutting means. Advantageously, the severing of the plant material directly before the pressing together of the long-stem plant material located in the compression chamber can occur in an especially simple manner, if the cutting unit with the cutting means is associated with the inlet opening of the compression chamber. A cutting tool can be provided, for example, as the cutting unit.

Exemplary embodiments of the invention will be described in greater detail below with use of drawings. In the drawing:

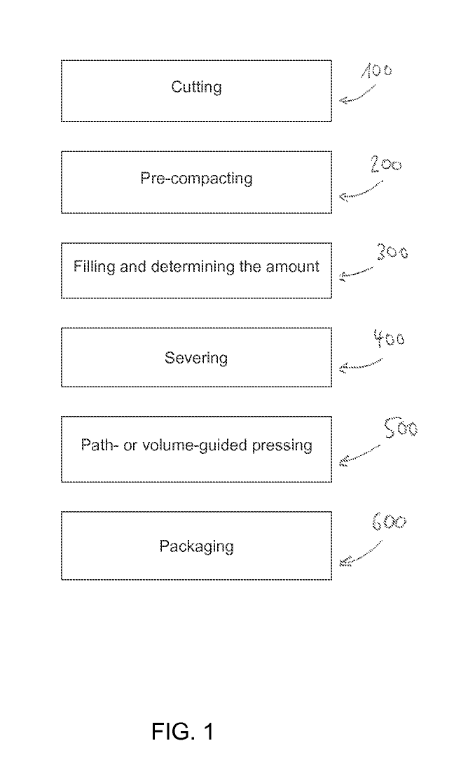

FIG. 1 shows a depiction of a process sequence;

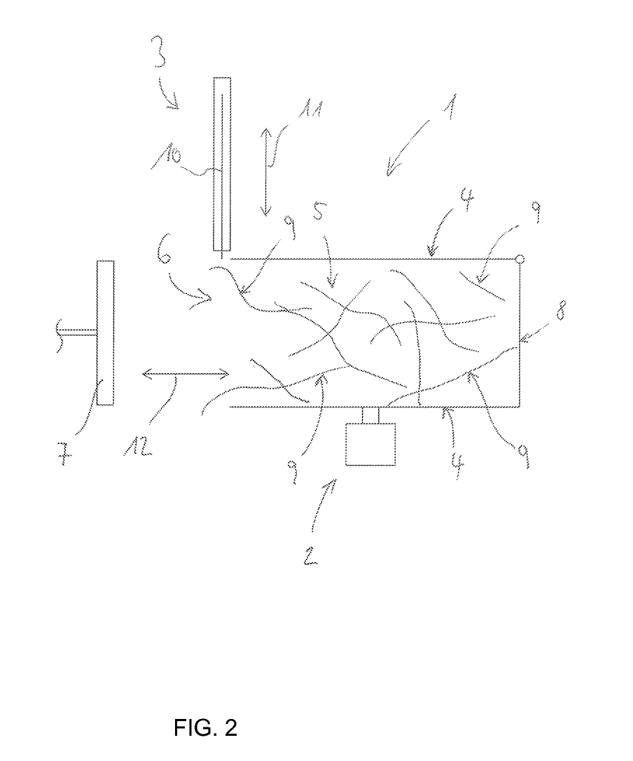

FIG. 2 shows a schematic diagram of a device of the invention during the introduction of pre-compressed long-stem plant material into a compression unit with a compression plunger in a home position; and

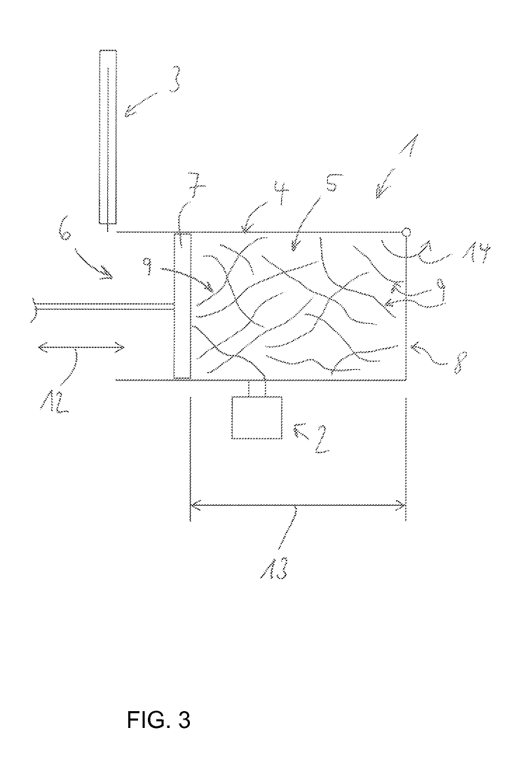

FIG. 3 shows the compression unit according to FIG. 2 during the pressing of the plant material with the compression plunger in an operating position.

A method for compressing long-stem plant material 9 according to FIG. 1 first provides that the plants grown in the field are severed or cut off by means of a suitable cutting device in the lower area of the plant stem (process step 100). Next, within the scope of further processing and recovery of biomass, the cut, long-stem plant material 9 is collected and pre-compacted (process step 200). The pre-compacted plant material is then introduced into a compression unit 1 (process step 300). The filling of compression unit 1 occurs particularly via an inlet opening 6. A part of the filling process of compression unit 1 is the determination of a weight of the introduced plant material 9 (fill weight or net weight) by means of suitable sensors, particularly weight sensors. As soon as a predefined amount of long-stem plant material 9 is introduced into compression unit 1, plant material 9 protruding out of compression unit 1 through inlet opening 6 is severed (process step 400). After the severing, the long-stem plant material 9 located in compression unit 1 is pressed to a predefined volume or a predefined path length (process step 500). After the pressing, the compressed plant material 9 is packaged to form transportable units (process step 600).

In particular the pre-compaction of the plant material 9 in process step 200 is optional. Process step 200 can therefore be omitted. The severing of the plant material projecting out of compression unit 1 in process step 400 is also optional. For example, process step 400 can be completely omitted. It is likewise possible to make the cutting process (process step 400) an integral component of the pressing process (process step 500). In this case, plant material 9 protruding from compression unit 1 is sheared off by means of the pressing tool (plunger 7) in a single process step and plant material 9 located in compression unit 1 is compressed.

A device of the invention according to FIG. 2 comprises substantially a compression unit 1, a weight determining unit 2, and a cutting unit 3. Compression unit 1 has a compression chamber 5 surrounded by housing walls 4, an inlet opening 6 associated with compression chamber 5, a compression plunger 7, and an end stop 8. Housing walls 4 delimit compression chamber 5, which is substantially rectangular in cross section, on the casing side. Inlet opening 6 and on the opposite side end stop 8 are formed on the front side. Plunger 7, shown in a home position, is associated moreover with inlet opening 6.

Weight determining unit 2 is provided operatively connected to housing wall 4 of compression unit 1. Weight determining unit 2 is formed so that the weight of housing wall 4, of end stop 8, and of long-stem plant material 9 provided in compression chamber 5 is determined with weight determining unit 2. Therefore, the total weight of the long-stem plant material 9, introduced into compression chamber 5, can be determined by means of weight determining unit 2 and the weight of compression unit 1 can be determined partially. For instance, the weight of plunger 7 in its home position is not determined concurrently.

Further, cutting unit 3 with a blade-shaped cutting means 10 is associated with inlet opening 6. Blade 10 can be moved in a cutting direction 11 to sever the plant material 9 protruding from compression chamber 5.

After the plant stems are severed, plant material 9 is first conveyed by means of a feeder unit in the direction of compression chamber 5 of compression unit 1. For example, a feed roller or a chain or screen conveyor can be provided for this purpose. Plant material 9 is then introduced via inlet opening 6 into compression chamber 5. The home position of plunger 7 is selected so that filling of compression chamber 5 can occur in a simple way. The weight of plant material 9 already introduced into compression chamber 5 is determined continuously by weight determining unit 2 during the filling. As soon as a target weight is reached, the filling of compression chamber 5 is stopped. For this purpose, for example, the feeder unit is stopped or disengaged. Plant material 9, located in the area of inlet opening 6, is then severed by means of cutting unit 3. After the protruding long-stem plant material 9 is cut off by means of blade 10 and blade 10 is then again disengaged, plunger 7 is advanced in compression direction 12. Plunger 7 then penetrates into compression chamber 5 and presses the long-stem plant material 9 located therein more and more together. In so doing, the pressure on housing walls 4 and particularly on end stop 8, which delimits compression chamber 5 on the front side opposite to plunger 7, increases.

FIG. 3 shows plunger 7 in the compression position, in which the long-stem plant material 9 is compressed to a minimal length 13. The compression of long-stem plant material 9 in this respect occurs path-controlled and not, as is generally typical today, force- or pressure-guided. After long-stem plant material 9 has been compressed to its minimal length 13, the thus formed rectangular bales are packaged to form a transportable unit and removed from compression chamber 5. This occurs, for example, by pivoting end stop 8 in pivoting direction 14 and moving the bale out of compression chamber 5 by a further forward movement of plunger 7.

While plunger 7 is moved from the home position to the compression position, the weight determination by means of weight determining unit 2 can be dispensed with.

The weight determination can occur with the use of commercial suitable weight sensors. The feeder unit, weight determining unit 2, an actuator unit (not shown) associated with plunger 7, and cutting unit 3 can work together via a common control unit (not shown). The control unit, moreover, can operate an optionally provided pre-compacting unit, which is used to pre-compact the long-stem plant material 9, to be introduced into compression chamber 5 of compression unit 1, during transport into compression chamber 5.

According to an alternative embodiment of the invention, end stop 8 can be formed as a fixed end stop. The removal of the pressed long-stem plant material 9 then occurs, for example, via a separately provided discharge opening or via inlet opening 6.

1. A method for compressing long-stem plant material, in which the long-stem plant material is introduced into a compression unit and pressed and in which the long-stem plant material pressed in the compression unit is packaged to form transportable units, wherein an amount of the long-stem plant material, predefined based on its weight, is introduced into the compression unit.

2. The method according to claim 1, wherein the weight of the long-stem plant material is determined continuously during the filling of the compression unit and that the filling of the compression unit is stopped as soon as the amount of long-stem plant material, predefined by means of a target weight, is reached and/or exceeded.

3. The method according to claim 1, wherein for determining the weight of the long-stem plant material introduced into the compression unit, a weight of at least one part of the compression unit and the weight of the long-stem plant material located therein are determined together by sensors and the weight of the at least one part of the compression unit is subtracted from the thus determined total weight.

4. The method according to claim 1, wherein for compressing the long-stem plant material in the compression unit, the long-stem plant material is pressed to a predefined compression volume and/or to a predefined compression length.

5. The method according to claim 1, wherein the long-stem plant material is pre-compacted before being introduced into the compression unit.

6. The method according to claim 1, wherein after the filling of the compression unit and before the pressing, long-stem plant material located only partially in the compression unit is severed such that a part of the long-stem plant material located in the compression unit is pressed after the severing and that a part of the long-stem plant material located outside the compression unit remains outside the compression unit during the pressing.

7. The method according to claim 1, wherein the introduction of the long-stem plant material into the compression unit and the pressing together of the long-stem plant material occurs sequentially, whereby the filling process of the compression unit is stopped during the pressing of the long-stem plant material located in the compression unit.

8. A device for compressing long-stem plant material with a compression unit, comprising:
a compression chamber for the long-stem plant material;
a feeder unit for introducing the long-stem plant material into the compression chamber of the compression unit, whereby the compression chamber has an inlet opening associated with the feeder unit, over which the long-stem plant material can be introduced into the compression chamber of the compression unit,
a plunger movable between a home position and a compacting position, which in the home position is arranged disengaged such that the long-stem plant material can be introduced into the compression chamber and which in the compression position is arranged plunged into the compression chamber such that the long-stem plant material is provided in the compression chamber pressed together to a geometrically predefined extent.

9. The device according to claim 8, wherein a weight determining unit is operatively connected to the compression unit such that a weight of at least one part of the compression unit and a weight of the long-stem plant material provided in the compression chamber of the compression unit can be determined by the weight determining unit.

10. The device according to claim 8, wherein a cutting unit is associated with the inlet opening of the compression chamber, whereby parts of the long-stem plant material protruding out of the compression chamber through the inlet opening can be cut by means of a cutting means of the cutting unit.
